(19) United States
(12) Patent Application Publication
(10) Pub. No.: US 2018/0374104 A1
(43) Pub. Date: Dec. 27, 2018

(54) AUTOMATED LEARNING OF DATA AGGREGATION FOR ANALYTICS

(71) Applicant: SAP SE, Walldorf (DE)

(72) Inventors: Robert Meusel, Mannheim (DE); Atreju Florian Tauschinsky, Walldorf (DE); Christine Preisach, Bruchsal (DE)

(21) Appl. No.: 15/633,401

(22) Filed: Jun. 26, 2017

(51) Int. Cl. G06Q 30/02; G05B 13/02

(52) U.S. Cl. CPC G06Q 30/0201; G05B 13/0265

(57) ABSTRACT

Methods, systems, and computer-readable storage media for automatically providing a predictive model for an asset made up of multiple sub-assets with actions including receiving asset data including data values associated with the asset and at least one of sub-asset of the multiple assets, providing, by the one or more processors, a set of features based on the asset data, and executing an iterative feature selection and supervised learning process, including, for each iteration: selecting a sub-set of features from the set of features, performing supervised learning over the sub-set of features to provide a predictive model, and determining an accuracy of the predictive model, the iterations are performed until the accuracy of the predictive model exceeds a threshold accuracy.

### BACKGROUND

Data analytics can be used in multiple contexts. An example context can include predictive maintenance of devices. For example, data associated with a device can be analyzed to predict when and/or what type of maintenance may be needed to maintain acceptable operation of the device. Data analytics, however, can be resource intensive (e.g., in terms of technical resources such as processors, memory, bandwidth), and can require a relatively high skill level (e.g., data science and domain expert with engineering background) for review and action based on analytical results. These constraints can inhibit a broader use of data analytics.

Further, data analytics can involve data provided from sub-assets (sub-components) of an overall component (system), as well as data form other sources (e.g., weather data, financial data). In other words, an asset that data analytics is to be processed over can be a compound of numerous other assets. In such circumstances, to capture the state of the overall asset, the states of the sub-assets need to be aggregated in an appropriate manner. Capturing (often complex) coherences between sub-assets and an overall asset is difficult, and can require significant domain knowledge.

### SUMMARY

Implementations of the present disclosure include computer-implemented methods for automated learning of data aggregation in data analytics. In some implementations, actions include receiving asset data including data values associated with the asset and at least one of sub-asset of the multiple assets, providing, by the one or more processors, a set of features based on the asset data, and executing an iterative feature selection and supervised learning process, including, for each iteration: selecting a sub-set of features from the set of features, performing supervised learning over the sub-set of features to provide a predictive model, and determining an accuracy of the predictive model, the iterations are performed until the accuracy of the predictive model exceeds a threshold accuracy. Other implementations of this aspect include corresponding systems, apparatus, and computer programs, configured to perform the actions of the methods, encoded on computer storage devices.

These and other implementations can each optionally include one or more of the following features: actions further include, in response to determining that the accuracy of the predictive model exceeds a threshold accuracy providing the predictive model including a feature set and a configuration as output to an analytics system; the set of features is provided based on the asset data using one of backward selection, forward selection, and genetic-based selection; the asset data includes at least time series data; the asset data includes one or more of score data, and sensor reading data; the set of features includes one or more of a sum, a minimum value, a maximum value, a count value, and a standard deviation; and determining an accuracy of the predictive model is based on one of k-fold cross-validation, and holdout sets.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example high-level architecture in accordance with implementations of the present disclosure.

FIG. 2 depicts an example conceptual architecture in accordance with implementations of the present disclosure.

FIG. 3 depicts an example process that can be executed in accordance with implementations of the present disclosure.

FIG. 4 is a schematic illustration of example computer systems that can be used to execute implementations of the present disclosure.

Like reference symbols in the various drawings indicate like elements.

### DETAILED DESCRIPTION

Implementations of the present disclosure are generally directed to aggregating data in data analytics systems. More particularly, implementations of the present disclosure provide for automatically determining feature sets, and a predictive model configuration for a predictive model of an asset made up of multiple sub-assets. In some implementations, actions include receiving asset data including data values associated with the asset and at least one of sub-asset of the multiple assets, providing, by the one or more processors, a set of features based on the asset data, and executing an iterative feature selection and supervised learning process, including, for each iteration: selecting a sub-set of features from the set of features, performing supervised learning over the sub-set of features to provide a predictive model, and determining an accuracy of the predictive model, the iterations are performed until the accuracy of the predictive model exceeds a threshold accuracy. In general, and as described in further detail herein, implementations of the present disclosure provide for automated learning of optimized to aggregation (hierarchical and temporal) to reflect the current or likely future state of an asset.

Implementations of the present disclosure are described in further detail herein with reference to an example context of data analytics for predictive maintenance. This can be generally referred to as predictive maintenance and services (PdMS). An example PdMS includes the PdMS System provided by SAP SE of Walldorf, Germany. In some examples, data is processed using data analytics to provide maintenance data on one or more devices, and/or to perform tasks associated with assets (e.g., issuing maintenance tickets). It is contemplated, however, that implementations of the present disclosure can be applied in an appropriate context.

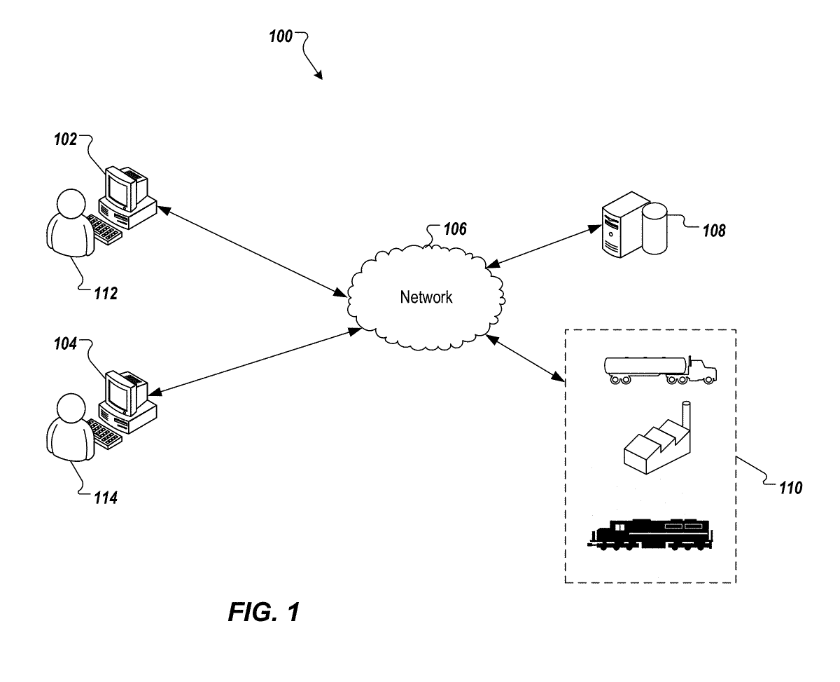

FIG. 1 depicts an example architecture 100 in accordance with implementations of the present disclosure. In the depicted example, the example architecture 100 includes one or more client devices 102, 104, a network 106, a server system 108, and assets 110. The server system 108 includes one or more server devices and databases (e.g., processors, memory). In the depicted example, respective users 112, 114 interact with the client devices 102, 104. In an example context, the users 112, 114 can include users (e.g., enterprise operators, maintenance agents), who interact with one or more a data analytics system hosted by the server system 108.

In some examples, the client devices 102, 104 can communicate with the server system 108 over the network 106. In some examples, the client devices 102, 104 can include any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 108 includes at least one server and at least one data store. In the example of FIG. 1, the server system 108 is intended to represent various forms of servers including, but not limited to a web server, an application server, a proxy server, a network server, and/or a server pool. In general, server systems accept requests for application services and provides such services to any number of client devices (e.g., the client devices 102, 104 over the network 106).

In some implementations, one or more data stores of the server system 108 store one or more databases. In some examples, a database can be provided as an in-memory database. In some examples, an in-memory database is a database management system that uses main memory for data storage. In some examples, main memory includes random access memory (RAM) that communicates with one or more processors (e.g., central processing units (CPUs)), over a memory bus. An-memory database can be contrasted with database management systems that employ a disk storage mechanism. In some examples, in-memory databases are faster than disk storage databases, because internal optimization algorithms can be simpler and execute fewer CPU instructions (e.g., require reduced CPU consumption). In some examples, accessing data in an in-memory database eliminates seek time when querying the data, which provides faster and more predictable performance than disk-storage databases. An example in-memory database system includes SAP HANA provided by SAP SE of Walldorf, Germany.

In accordance with the example context, the assets 110 can include entities, for which predictive maintenance is to be conducted. Example assets can include, without limitation, cars, trucks, trains, planes, boats, ships, buildings, factories, or components thereof (e.g., engine, motor, compressor, HVAC unit, etc.). In some examples, an asset can include one or more sub-assets (sub-components). The terms asset and sub-asset are used inter-changeably herein. In general, an asset (and sub-asset) can include any appropriate entity, for which data can be provided, and data analytics can be performed. In some examples, data associated with each asset 110 is provided to the server system 108 over the network 106, which data is processed by the data analytics system, as described in further detail herein.

In some implementations, data includes information technology (IT) data, and operational technology (OT) data. In some examples, IT data includes data provided from one or more enterprise systems. For example, an enterprise system can include an inventory of assets managed by a respective enterprise, the inventory recording assets by respective identifiers (unique identifiers), and other relevant information (e.g., description, part number, location, identifiers of sub-assets of the asset). In some examples, IT data is stored in a data store (e.g., of the server system 108), and can be retrieved based on identifiers associated with assets. For example, a database can be queried based on an asset identifier, and IT data associated with the respective asset can be provided in response to the query.

In some examples, OT data includes data provided from one or more sensors. Example sensors can include sensors integrated into an asset (e.g., environmental (pressure, temperature) sensors, speed (RPM) sensors, fluid (oil, coolant) level sensors. Example sensors can include sensors that are independent of an asset, but that monitor data associated with the asset (e.g., video cameras, environmental (pressure, temperature) sensors, motion sensors). For example, sensors can be included in a networked device that is proximate to an asset, and that provides data relevant to the asset. In some examples, OT data is stored in a data store (e.g., of the server system 108), and can be retrieved based on identifiers associated with assets, and/or identifiers assigned to sensors, and/or devices associated with assets. In some examples, devices associated with assets can include so-called Internet-of-things (IoT) devices. For example, a video camera monitors a particular asset and includes an identifier. An identifier of the video camera can be correlated to an identifier of the asset, and recorded in the enterprise system. Data provided by the video camera (e.g., video, images) can be stored in a database based on the identifier of the video camera and/or the identifier of the asset. The data can be queried based on the asset identifier and/or the video camera identifier, and OT data associated with the respective asset can be provided in response to the query.

As introduced above, and in accordance with the example context, the area of IoT condition monitoring, and predictive maintenance includes the prediction of upcoming expected and/or unexpected maintenance-relevant events. In general, the objects of predictive analytics can include relatively complex assets (e.g., a compressor, a train, a power plant). Assets can range from granular-level devices to systems made up of multiple (e.g., tens, hundreds, thousands) of devices. For example, an asset can be a compound of several sub-assets, which possibly are again compounds of other sub-assets. In the predictive maintenance context, and as introduced above, assets can be equipped with sensors, which are responsive to environment and/or activity, and capture data values.

In some implementations. predictive maintenance at least partially includes determining a state of an asset of interest. In cases, where the asset is made up of numerous sub-assets, the states of the sub-assets need to be aggregated in a suitable way. Also, in order to determine the current and/or future state of an asset, relevant data values from sensors, IoT devices, and the like may need to be aggregated. As an example, the status of the train engine (e.g., sub-asset of a train) can be indicated as red (e.g., maintenance is required), in response to determining that the train engine had four misfires in the last 24 operating hours. For example, the status is determined based on observations and predictive analytics indicating that there is a sufficiently high probability that the train will fail within the next 24 operating hours. From this, as without the engine, the train cannot be operated. Consequently, the status of the train (e.g., asset made up of sub-assets) is also red. In comparison, the status of the train is not red, if, for example, the status of a light (e.g., sub-asset of the train) is red, because the train can still be operated without the light.

Capturing complex coherences in predictive analytics can be difficult, and requires specific domain knowledge. Although domain knowledge might be present, all coherences might not be covered or taken into account. Furthermore, aggregated or calculated measures might not be taken into account by domain expert.

In traditional PdMS systems, the aggregation (e.g., temporal, hierarchical) of data is manually setup by a set of rules, which reflect the conditions for different states of assets. Further, the different available inputs (e.g., from sensors, external data, IT/OT data, as well as calculated information such as sums and outlier scores), and their inputs to the status of an asset are difficult to keep track of Due to the variety of inputs and domain-specific requirements, the static nature of aggregation in traditional systems is problematic. Further, the aspect of time needs to be taken into account, but is also highly domain dependent. It is, however, clear that—at least for the outlier scores—the meaningfulness of one single score might be limited, but the co-occurrence of many high outlier scores might be more helpful. In addressing score calculation on different levels of granularity within the asset hierarchy, it is necessary to transfer the status of a component into the status of the overall asset. This can lead to relatively complex rules for data aggregation.

In view of the foregoing, and as described in further detail herein, implementations of the present disclosure are directed to automatic learning of data aggregation for data analytics. In general, implementations of the present disclosure enable flexibility in determining and revising sets of rules for aggregating data in predictive analytics systems. In some implementations, a set of features and a configuration are provided for a computer-implemented supervised learner, which provides an aggregation for data to be used in a predictive analytics system.

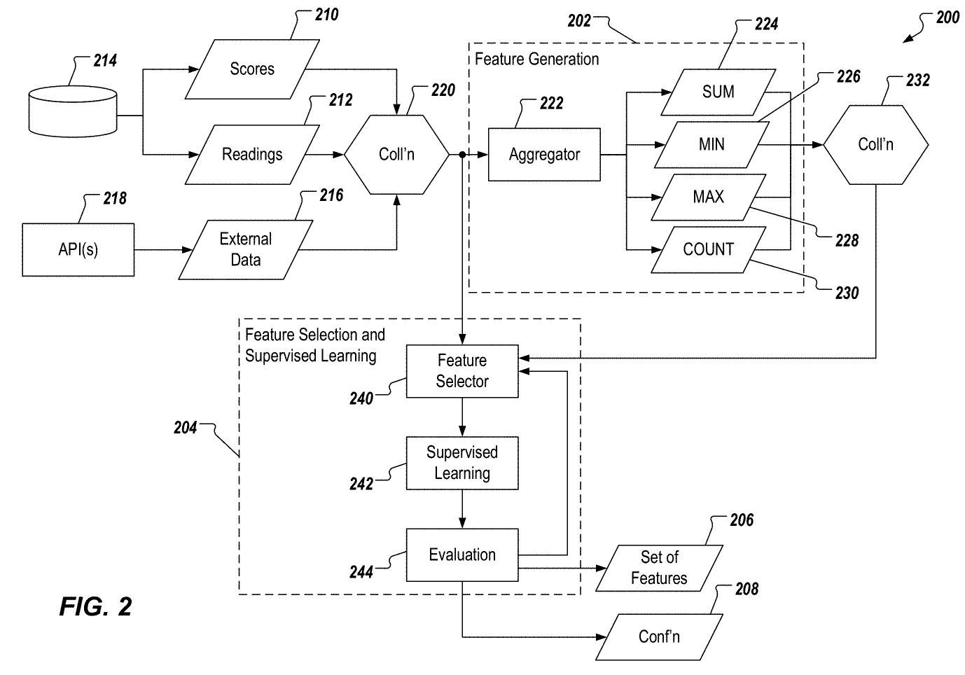

Implementations of the present disclosure are described in further detail herein with reference to FIG. 2, which depicts an example conceptual architecture 200 in accordance with implementations of the present disclosure. In general, implementations of the present disclosure receive input data and learn, based on reported incidents and feedback (referred to herein as labels) the current or future state of an asset. In a first phase, implementations of the present disclosure generate, from the available data, features, which represent possible aggregates. In a second phase, implementations of the present disclosure select the most promising features, based on one or more feature selection methodologies, and feeds selected features into a supervised learning system. The output of the learning is evaluated, and performance is fed back to refine the feature selection until a suitable (e.g., optimized) solution is determined.

The example conceptual architecture 200 includes a feature generation phase 202 (the first phase introduced above), and a feature selection and supervised learning phase 204 (the second phase introduced above). In general, and as described in further detail herein, for each asset, for which a state is to be determined by aggregating data of sub-assets, a set of features 206, and a configuration 208 are provided. More particularly, the output of the feature selection and supervised learning phase 204 can be described as a predictive model including a set of rules, which are derived from the set of input values a current status (e.g., health status) of the asset. From this predictive model, an explanation for a particular state determination can be provided, which a user can interpret and is able to work with (e.g. a set of rules, derived from a decision tree).

In some implementations, input to the feature generation phase 202 can include any available and appropriate data for the asset in question. This can include, for example, and without limitation, raw data (e.g., sensor readings), IoT data, external data (e.g., weather data), as well as score data (e.g., scores calculated from a maximum likelihood estimation (MLE) of a PdMS system, aggregates over all mentions (number of outliers in the last hour)). In the case of a hierarchical aggregation, the input can also include aggregations of sub-assets. In the depicted example, score data 210, and readings data 212 are provided from a data repository 214 (e.g., a database of a PdMS system). External data 216 is provided from one or more external services. For example, the external data 216 can be received through one or more application program interfaces (APIs) 218 (e.g., weather data received from a weather data service, stock market data). In some examples, external data includes data from outside of the PdMS system. This can either be data, which is not stored within PdMS system databases (e.g., some arbitrary system). As one example, to predict if something will go wrong with a pump, it can be learned that some constellation of sensor data leads to a problem when it begins to rain. In this case, external data (weather) is used to learn the aggregation for the particular pump. Other input can be the humidity (e.g. within a room, an area), which influences some measurements and the output of a production/assembly line, for example.

A data collection 220 is provided, and is input to the feature generation phase 202. Among other data, the data collection 220 includes time series data (e.g., respective time series of a data values as they change over time). An aggregator 222 of the feature generation phase 202 aggregates the data provided in the collection 220. More particularly, the aggregator provides different types of aggregates (e.g., based on received time series data), which can be used as features in the feature selection and supervised learning phase 204. In the depicted example, output of the aggregator 222 includes sum data 224, min data 226, max data 228, and count data 230. It is contemplated, however, that any appropriate data can be provided from the aggregator 222 (e.g., standard deviations). For example, relatively complex aggregations can be provided within differing timeframes (e.g., the feature generation can create aggregates based on the input data for different sizes of windows). As an example, features can be provided that are based on an hour-long window, averaging at 15 minutes intervals (4 times over the hour), and other features can be based on averaging over the whole hour. The data output by the feature generation phase 202 is provided as a feature collection 232, and is input to the feature selection and supervised learning phase 204.

As described in further detail herein, the feature selection and supervised learning phase 204 provides an iterative approach, where each iteration is based on a respective set of features to provide a predictive model that is evaluated. Iterations continue until the evaluation of a predictive model indicates that the predictive model is satisfactory, at which point the feature selection and supervised learning phase 204 provides the output described herein. In some examples, a predictive model is determined to be satisfactory, if a respective accuracy exceeds a threshold accuracy. In some examples, if a predictive model is determined to not be satisfactory, a next iteration is performed with by providing a refined feature set.

In the depicted example, a feature selector 240 selects a set of features from the feature collection 232 based on one or more feature selection routines. In some examples, feature selection can be described as selecting a subset of relevant features for use in a predictive model for predictive analytics. Feature selection enables irrelevant features (e.g., a feature that has little to no impact on a result of the predictive model) and/or redundant features to be removed from a resulting predictive model. In this manner, the resulting predictive model is more efficient in terms of computational cost (e.g., processing power, memory required to execute predictive analytics using the model). Example feature selection routines can include, but are not limited to, backward selection, forward selection, and genetic-based selection. In some examples, forward feature selection includes evaluating training data over multiple different sub-sets of features, where features are iteratively added to sub-sets to determine which sub-set of features performs the best. In some examples, reverse feature selection includes evaluating training data over multiple different sub-sets of features, where features are iteratively removed from sub-sets to determine which sub-set of features performs the best.

In the depicted example, a supervised learning module 242 is provided, and receives the feature selection (sub-set of features) provided by the feature selector 240. The supervised learning module 242 performs supervised learning using the feature selection to provide a predictive model. In some examples, labels for the training data are provided from documented failures for the observed type of asset from the historical data. Such historical data can be provided, for example, from ticket/notification systems, and/or documented work activities (e.g., “Engineer replaced part Z from pump due to leakage”). For a given set of features, and depending on the expected output (e.g., nominal, numerical) different kinds of classification or regression are performed to provide the predictive model. In some implementations, the predictive model can be selected to be a human-readable predictive model (e.g., decision trees, rule learners (RIPPER), cluster-based model).

In the depicted example, an evaluation module 244 is provided, which evaluates the predictive model at each iteration to determine whether the predictive model is satisfactory. In order to evaluate a predictive model, strategies, such as k-fold cross-validation, and/or holdout sets can be implemented. In some examples, the evaluation provides an accuracy value (e.g., an error value, such as mean-squared error (MSE)) that indicates a relative accuracy of the predictive model. In some examples, the accuracy value is compared to a threshold accuracy. If the accuracy value exceeds the threshold accuracy, the predictive model is determined to be satisfactory. If the accuracy value does not exceed the threshold accuracy, the predictive model is determined to be unsatisfactory, and a next iteration is performed.

In some examples, the performance of the predictive model is heavily influenced by the available features. Consequently, implementations of the present disclosure wrap classification of the predictive model within the feature selection. By this, both parts, configuration (parameters) of the classification algorithms, and the selected features, can be optimized hand in hand. An example could be, that for classification algorithm A with parameter configuration A′ the set of features S is the best, but for the classification algorithm B with the parameter configuration B′ the set of features S′ is the best. Therefore, those two sets (parameters and features) are optimized for a given dataset in combination, and not alone.

Implementations of the present disclosure further provide for an initial set-up for automated determining of feature sets, and a predictive model configuration. In some examples, it may be impractical that users will grant a machine-learning system, such as that described herein, the full freedom to learn data aggregations. For this reason, among other possible reasons, an interactive mode to set-up the machine-learning system is provided.

In a first example, a user can start with a rule (model) that the user provides based on the available domain knowledge. The user-provided model can be processed in an initial iteration of the feature selection and supervised learning phase, which results in improvements to the rule (model) in subsequent iterations. In some examples, the improvements can be constrained to provide actionable suggestions (e.g., include additional features in the rule), and avoid un-actionable suggestions (e.g., change rule x<=1 into x<1.1 where x can only have integer values).

In a second example, the machine-learning system of the present disclosure can provide an initial predictive model, which the user can use as a template, and improve with available domain knowledge. In some examples, a complexity of the initial predictive model can be adjusted by user-defined parameters (e.g. the length of the rules). For example, an initial predictive model can include a set of features that is highly discriminatory with respect to the available labels, and provide one or more rules (e.g. x>1.1). Beginning with the initial predictive model, the user can normalize/optimize/change the suggestions (e.g., towards x>1.5, as the user knows that x is typically 1, 2, or 3, but never 1.1). The user-modified, initial predictive model can then be used as the starting iteration in the feature selection and supervised learning phase.

Implementations of the present disclosure further provide for retraining and reinforcement learning. In some examples, a requirement of the automated machine-learning of the present disclosure is the fast and direct integration of feedback. This can be necessary in cases where, for example, the current aggregation rules produce wrong aggregations, which do not reflect the real state of the asset being modeled. Accordingly, implementations of the present disclosure can be adapted to directly incorporate feedback in order to improve the predictive model. In some examples, this can be achieved by retraining the predictive model using more finely grained labels, and/or by applying an online/stream-based classification algorithm (e.g., Hoeffding-Trees), which can directly reflect feedback.

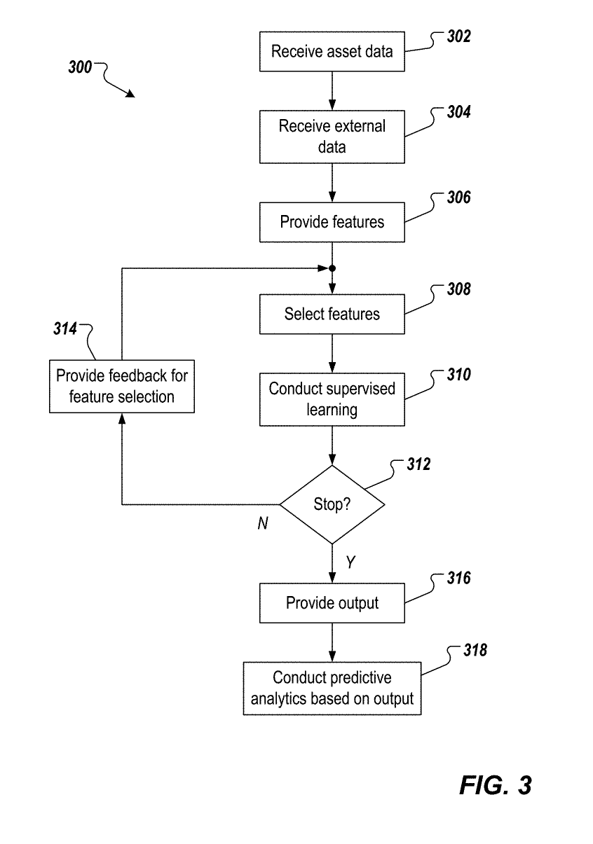

FIG. 3 depicts an example process 300 that can be executed in accordance with implementations of the present disclosure. In some examples, the example process 300 can be provided by one or more computer-executable programs executed using one or more computing devices.

Asset data is received (302). For example, asset data is provided for an asset, for which a predictive model including data aggregation rules is to be determined. In some examples, the asset data is received from a datastore of a PdMS system that is monitoring the asset. In some examples, the asset is made up of multiple sub-assets, each sub-asset having respective asset data that is aggregated to determine a state of the asset. In some examples, the asset data includes scores (e.g., calculated values), and sensor data (e.g., readings from asset sensors) for the asset, and sub-assets. External data is received (304). For example, external data that may be relevant to a state of the asset can be provided from one or more third-party data providers (e.g., weather data received from a third-party weather data provider through a respective API).

A set of features is provided (306). For example, and as described herein, the feature generation phase 202 of FIG. 2 processes the asset data (and external data, if any) to provide the set of features. A sub-set of features is selected from the set of features (308). For example, and as described herein, the feature selector 240 of the feature selection and supervised learning phase 204 of FIG. 2 selects an initial sub-set of features from the set of features provided from the feature generation phase 202 of FIG. 2. Supervised learning is performed based on the sub-set of features (310). For example, and as described herein, the supervised learning module 242 of FIG. 2 provides a predictive model based on the sub-set of features provided form the feature selector 240.

It is determined whether the predictive model is sufficiently accurate (312). For example, and as described herein, the predictive model provided from the supervised learning module 242 is evaluated by the evaluation module 244 (e.g., using k-fold cross-validation, and/or holdout sets). In some examples, the evaluation provides an accuracy value (e.g., an error value, such as mean-squared error (MSE)) that indicates a relative accuracy of the predictive model. In some examples, the accuracy value is compared to a threshold accuracy. If the accuracy value exceeds the threshold accuracy, the predictive model is determined to be satisfactory. If the accuracy value does not exceed the threshold accuracy, the predictive model is determined to be unsatisfactory, and a next iteration is performed. If the predictive model is determined to be unsatisfactory, the example process 300 loops back to provide feedback for feature selection (314), and a next iteration of feature selection and supervised learning is performed (e.g., a new sub-set of features is selected, and supervised learning is performed based thereon.

If the predictive model is determined to be satisfactory, output is provided (316). For example, the feature selection and supervised learning phase 204 provides the set of features 206 (e.g., the last-selected sub-set of features), and the configuration 208 are provided. Predictive analytics are conducted based on the output (318). For example, an analytics system (e.g., PdMS system) performs analytics on incoming asset data using the predictive model.

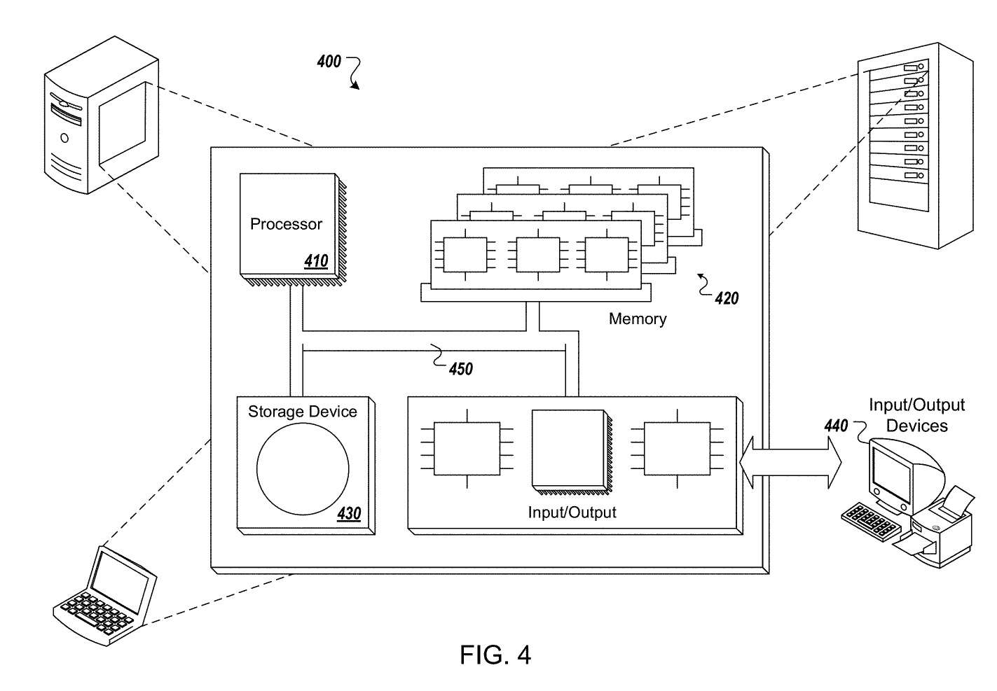

Referring now to FIG. 4, a schematic diagram of an example computing system 400 is provided. The system 400 can be used for the operations described in association with the implementations described herein. For example, the system 400 may be included in any or all of the server components discussed herein. The system 400 includes a processor 410, a memory 420, a storage device 430, and an input/output device 440. The components 410, 420, 430, 440 are interconnected using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the system 400. In one implementation, the memory 420 is a computer-readable medium. In one implementation, the memory 420 is a volatile memory unit. In another implementation, the memory 420 is a non-volatile memory unit. The storage device 430 is capable of providing mass storage for the system 400. In one implementation, the storage device 430 is a computer-readable medium. In various different implementations, the storage device 430 may be a floppy disk device, a hard disk device, an optical disk device, or a tape device. The input/output device 440 provides input/output operations for the system 400. In one implementation, the input/output device 440 includes a keyboard and/or pointing device. In another implementation, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for automatically providing a predictive model for an asset made up of multiple sub-assets, the method being executed by one or more processors and comprising:
receiving, by the one or more processors, asset data, the asset data comprising data values associated with the asset and at least one of sub-asset of the multiple assets;
providing, by the one or more processors, a set of features based on the asset data; and
executing, by the one or more processors, an iterative feature selection and supervised learning process, comprising, for each iteration:
selecting a sub-set of features from the set of features,
performing supervised learning over the sub-set of features to provide a predictive model, and
determining an accuracy of the predictive model;
wherein, iterations are performed until the accuracy of the predictive model exceeds a threshold accuracy.

2. The method of claim 1, further comprising, in response to determining that the accuracy of the predictive model exceeds a threshold accuracy providing the predictive model including a feature set and a configuration as output to an analytics system.

3. The method of claim 1, wherein the set of features is provided based on the asset data using one of backward selection, forward selection, and genetic-based selection.

4. The method of claim 1, wherein the asset data comprises at least time series data.

5. The method of claim 1, wherein the asset data comprises one or more of score data, and sensor reading data.

6. The method of claim 1, wherein the set of features comprises one or more of a sum, a minimum value, a maximum value, a count value, and a standard deviation.

7. The method of claim 1, wherein determining an accuracy of the predictive model is based on one of k-fold cross-validation, and holdout sets.

8. A non-transitory computer-readable storage medium coupled to one or more processors and having instructions stored thereon which, when executed by the one or more processors, cause the one or more processors to perform operations for automatically providing a predictive model for an asset made up of multiple sub-assets, the operations comprising:
receiving asset data, the asset data comprising data values associated with the asset and at least one of sub-asset of the multiple assets;
providing a set of features based on the asset data; and
executing an iterative feature selection and supervised learning process, comprising, for each iteration:
selecting a sub-set of features from the set of features,
performing supervised learning over the sub-set of features to provide a predictive model, and
determining an accuracy of the predictive model;
wherein, iterations are performed until the accuracy of the predictive model exceeds a threshold accuracy.

9. The computer-readable storage medium of claim 8, wherein operations further comprise, in response to determining that the accuracy of the predictive model exceeds a threshold accuracy providing the predictive model including a feature set and a configuration as output to an analytics system.

10. The computer-readable storage medium of claim 8, wherein the set of features is provided based on the asset data using one of backward selection, forward selection, and genetic-based selection.

11. The computer-readable storage medium of claim 8, wherein the asset data comprises at least time series data.

12. The computer-readable storage medium of claim 8, wherein the asset data comprises one or more of score data, and sensor reading data.

13. The computer-readable storage medium of claim 8, wherein the set of features comprises one or more of a sum, a minimum value, a maximum value, a count value, and a standard deviation.

14. The computer-readable storage medium of claim 8, wherein determining an accuracy of the predictive model is based on one of k-fold cross-validation, and holdout sets.

15. A system, comprising:
a computing device; and
a computer-readable storage device coupled to the computing device and having instructions stored thereon which, when executed by the computing device, cause the computing device to perform operations for automatically providing a predictive model for an asset made up of multiple sub-assets, the operations comprising:
receiving asset data, the asset data comprising data values associated with the asset and at least one of sub-asset of the multiple assets;
providing a set of features based on the asset data; and
executing an iterative feature selection and supervised learning process, comprising, for each iteration:
selecting a sub-set of features from the set of features,
performing supervised learning over the sub-set of features to provide a predictive model, and
determining an accuracy of the predictive model;
wherein, iterations are performed until the accuracy of the predictive model exceeds a threshold accuracy.

16. The system of claim 15, wherein operations further comprise, in response to determining that the accuracy of the predictive model exceeds a threshold accuracy providing the predictive model including a feature set and a configuration as output to an analytics system.

17. The system of claim 15, wherein the set of features is provided based on the asset data using one of backward selection, forward selection, and genetic-based selection.

18. The system of claim 15, wherein the asset data comprises at least time series data.

19. The system of claim 15, wherein the asset data comprises one or more of score data, and sensor reading data.

20. The system of claim 15, wherein the set of features comprises one or more of a sum, a minimum value, a maximum value, a count value, and a standard deviation.
